(19) United States
(12) Patent Application Publication
(10) Pub. No.: US 2008/0236502 A1
(43) Pub. Date: Oct. 2, 2008

(54) Livestock creep feeder having a foldable panel assembly with pivotally interconnected panels

(76) Inventors: John Elias, Morden (CA); David Elias, Morden (CA); Peter Friesen, Winkler (CA)

Correspondence Address: ADE & COMPANY INC., 2157 Henderson Highway, WINNIPEG, MB, R2G1P9, CA

(21) Appl. No.: 12/057,544

(22) Filed: Mar. 28, 2008

Related U.S. Application Data
(60) Provisional application No. 60/908,511, filed on Mar. 28, 2007.

(51) Int. Cl. A01K 5/00; A01K 29/00

(52) U.S. Cl. 119/52.4; 119/840

(57) ABSTRACT

A creep feeder features a frame having an enclose defined thereon and a trough supported within the enclosure, the enclosure including end walls disposed at opposite ends of the trough and blocking access to the trough from three sides thereof while defining an open side of the feeder through which the trough is accessible. A panel assembly having opposite ends pivotally supported on the frame proximate the end walls features a plurality of panels pivotally interconnected between the opposite ends to allow folding of the panel assembly. The panels are foldable from a deployed condition, in which the panel assembly extends from the opposite ends thereof away from the trough to enclose a feeding area spanning from the trough past the open side of the feeder, to a stowed condition in which the panel assembly extends between the end walls in proximity to the open side to effect closing thereof.

This application claims the benefit under 35 U.S.C. 119(e) of U.S. provisional application Ser. No. 60/908,511, filed Mar. 28, 2007.

This invention relates generally to livestock feeders, and more particularly to creep feeders having fence panels deployable to close off a feed area to livestock exceeding a predetermined size.

### BACKGROUND OF THE INVENTION

In agriculture, creep feeding is the practice of supplying supplemental feed to young livestock prior to weaning. Successful creep feeding of course requires that the older livestock amongst the herd somehow be prevented from consuming the supplemental feed intended for the young. This separation of the livestock can be a daunting task when attempting to creep feed the young of a grazing herd.

Conventional creep feeders have an elongate shape with a trough running along each side into which supplemental feed is introduced. In order to allow only the young to access the feed, three fence panels are set up to enclose a generally rectangular feeding area closed on the fourth side by the trough area of the feeder itself. At least the panel opposite the feed trough is divided into a plurality of open sections called gates, each of suitable width and height to allow the entry of young livestock, yet to be weaned, into the feeding area while preventing entry by the older, larger livestock.

It is well known to provide creep feeders in which the panels are removable from the feeder to allow conversion to a conventional feeder allowing access by livestock of all sizes. It is also known to provide portable creep feeders that can be collapsed into a transport state by moving the panels out of the use position in which they enclose the feeding area into a storage position on the feeder, thereby facilitating transport therewith. To avoid having to disassemble the three panels from the feeder, and possibly from one another, only later to have to reassemble them for use, fold-up creep feeders are available in which the three panels are assembled to form a rigid, generally U-shaped structure pivotally connected at its opposite ends to the end walls of the feeder. The structure is pivotable about a horizontal axis to move from a deployed use position, in which the side panel opposite the feeding trough rests on the ground to enclose the feeding area, to a stowed transport position, in which the two end panels project upward along the end walls of the feeder to position the side panel overtop the eaves or roof of the feeder. In the stowed position, the panels are out of the way to allow use of the creep feeder as a conventional feeder and also do not project laterally therefrom, thereby reducing its width for transport.

Whether the panels are installed into place by assembling them to the feeder or by folding them down out of a stowed position, it is possible that older livestock may get into the feeding area with access to the trough before the panels are functionally in place. Overcoming this problem with a conventional creep feeder is best accomplished by having more than one person present, so that one individual can set up the panels while the other can act to keep livestock out of the feeding area. An individual attempting to set up a conventional creep feeder may undergo several attempts at putting the panels in place before successfully closing off access to the trough by older livestock if one or more animals are determined to enter the feeding area.

As a result, it is desirable to provide a creep feeder that can automatically prevent access to the feeding area by livestock other than the young it is intended to feed during deployment of the fence panels.

### SUMMARY OF THE INVENTION

According to a first aspect of the invention there is provided a creep feeder comprising:

a frame;

an enclosure defined on the frame;

a trough supported within the enclosure, the enclosure blocking access to the trough from three sides thereof while defining an open side of the feeder through which the trough is accessible, the enclosure including end walls disposed at opposite ends of the trough;

a panel assembly having opposite ends pivotally supported on the frame proximate the end walls of the enclosure and comprising a plurality of panels pivotally interconnected between the opposite ends to allow folding of the panel assembly;

the panels being foldable from a deployed condition, in which the panel assembly extends from the opposite ends thereof proximate the end walls in a direction away from the trough through the open side to enclose a feeding area spanning from the trough past the open side of the feeder, to a stowed condition in which the panel assembly extends between the end wails in proximity to the open side to effect closing thereof.

Preferably the panel assembly comprises two end panels each pivotally mounted proximate a respective one of the end walls and a side panel extending between the two end panels at an end of the feeding area opposite the trough with the panel assembly in the deployed condition.

Preferably the two end panels are of generally equal length.

Preferably the side panel is shorter in length than each of the two end panels.

Preferably a sum of a linear distance between the opposite ends of the panel assembly and a length of the side panel is generally equal to a sum of lengths of the two end panels.

Preferably each end panel comprises at least one gate spaced at a distance from a respective one of the ends of the panel assembly.

Preferably each panel comprises at least one gate.

Preferably each gate is spaced along the panel assembly from each of the opposite ends thereof.

Preferably there is provided an elongate flexible member extending along the panel assembly between top and bottom limits thereof from one panel to another to define a height of a plurality of gates.

Preferably the elongate flexible member is supportable at varying heights on the panel assembly to vary the height of the plurality of gates.

Preferably there is provided a plurality of sets of supporting elements, the sets of supporting elements being spaced at different heights along the panel assembly to allow the flexible member to be supported at varying heights on the panel assembly to change the height of the plurality of gates.

Preferably the supporting elements of each set comprise rings fixed to the panel assembly through which the flexible member can be passed and be secured to the panel assembly past each end of the set.

Preferably there is provided at least one locking device for locking two of the panels together in the stowed condition.

Preferably each locking device comprises a flexible element secured at a first end to a respective one of the two panels for tying to the other of the two panels.

Preferably a second end of the flexible element opposite the first end has a securing element thereon for securing the second end back onto the respective one of the two panels after wrapping the flexible element around a member of the other of the two panels.

Preferably the securing element comprises an S-hook sized to hook around and span between a pair of spaced engagement points on the respective one of the two panels.

Preferably the at least one locking device comprises a plurality of locking devices, each arranged to secure together an adjacent pair of panels in the stowed condition.

Preferably there is provided an elongate locking member connectable at a first end thereof to the panel assembly proximate an axis about which two of the panels pivot relative to one another and connectable at a second end opposite the first end to the frame with the panel assembly in the deployed condition to inhibit movement of the panel assembly.

Preferably the panel assembly comprises a mounting device to which the locking member is mountable to extend along a respective one of the plurality of feeder panels for storage.

Preferably the mounting device comprises a pair of hooks disposed at opposite ends of one of the two panels over which open ends of the locking member are slidable, the hooks being dimensioned to project beyond an inner dimension of the open ends with the open ends fitted about shanks of the hooks.

Preferably each hook is mounted to a respective one of the two panels for movement therewith, mouths of the hooks extending in a common direction with the panel assembly in the deployed condition and extending in offset directions with panel assembly in the stowed condition.

Preferably the panel assembly comprises a hook proximate the axis about which the two panels pivot, the hook being sized to allow sliding of one of the open ends of the locking member thereover to a shank thereof to prevent linear withdrawal of the open end therefrom.

Preferably there is provided a blocker pivotally mounted to the locking member proximate the one of the open ends thereof, the blocker being pivotable with said on of the open ends fitted over the shank of the hook to depend downward from the locking member and block rotation of the locking member for removal from the hook by engagement with one of the two panels.

Preferably pivotal connections at the opposite ends of the panel assembly comprise at least one knuckle having a pin passed therethrough.

Preferably the at least one knuckle has an inner diameter exceeding an outer diameter of the pin to allow tilt of the panel assembly relative to the enclosure in the deployed condition.

Preferably the pivotal connections each comprise a plurality of knuckles supported on opposite ones of the frame and the panel assembly through which a pin is passed and the knuckle(s) supported on one of the frame and the panel assembly exceed the knuckle(s) supported on the other of the frame and the panel assembly in inner diameter.

Preferably the knuckle(s) supported on the frame exceed the knuckle(s) supported on the panel assembly in inner diameter.

Preferably the pin is removable from the knuckle to allow detachment of the panel assembly.

Preferably there is provided blocking members supported on the frame to block tilting of the panel assembly relative to the enclosure in the stowed condition.

Preferably the blocking members are supported on the pivotal connections at the opposite ends of the panel assembly.

Preferably the at least one knuckle of each of the pivotal connections at the opposite ends of the panel assembly supports a respective one of the blocking members.

### BRIEF DESCRIPTION OF THE DRAWINGS

In the accompanying drawings, which illustrate an exemplary embodiment of the present invention:

FIG. 1 is a perspective view of a creep feeder having a foldable panel assembly installed thereon and shown part way between a stowed condition and a fully deployed condition.

FIG. 2 is an enlarged perspective view of the foldable panel assembly of FIG. 1.

FIG. 3 is a perspective view of the foldable panel assembly of FIG. 1 in the fully deployed condition.

FIG. 4 is an elevational view of the foldable panel assembly of FIG. 1 in the stowed condition.

FIG. 5 is an enlarged perspective view of feeder-mounted components of a pivotal connection between the creep feeder and panel assembly of FIG. 1.

FIG. 6 is an enlarged perspective view of panel-mounted components of the pivotal connection between the creep feeder and panel assembly of FIG. 1.

FIG. 7 is a side elevational view of the creep feeder of FIG. 1 with the foldable panel assembly removed.

### DETAILED DESCRIPTION

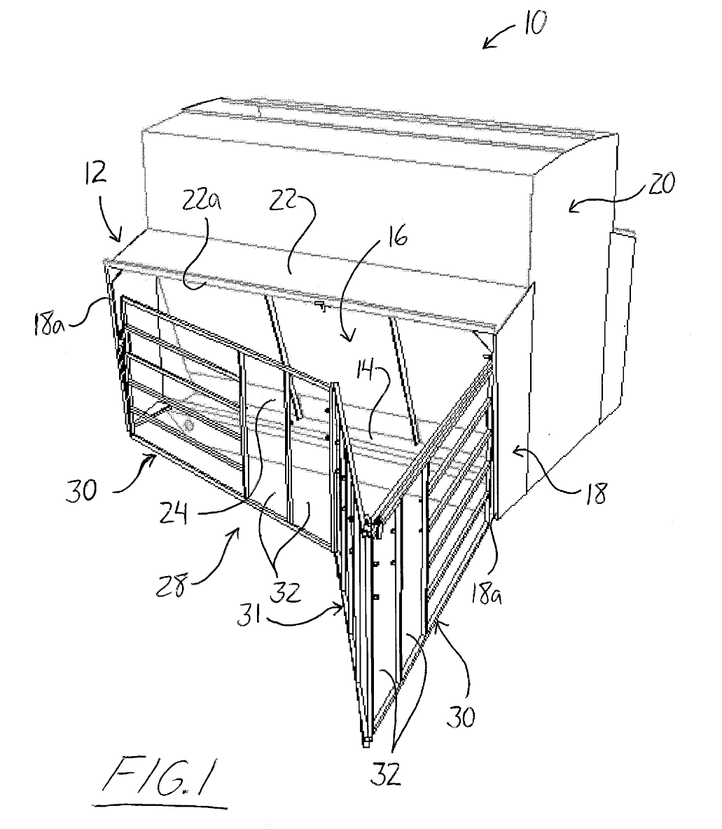

FIG. 1 shows a creep feeder 10 that, aside from a panel assembly thereof used to enclose a feeding area to prevent access by larger members of a livestock herd, is of a conventional basic structure. The feeder 10 is of the portable type towable on a wheeled frame (not shown) having an enclosure 12 defined on each side thereof arranged to limit access to a feeding trough 14 through an open side 16 of the feeder. The enclosure features two end walls 18 at opposite ends of the feeding trough 14 projecting laterally from a feed storage container 20 carried on the frame and defining a central portion of the feeder 10 formed between the two enclosures on opposite sides thereof. An eave 22 also projects laterally from the storage container 20 and extends between the end walls 18 at the top ends thereof to cover the trough 14 disposed below it from exposure to rain, snow, etc. Chutes 24 defined on a side wall of the container 20 are slidable upward to open the bottom of the container 20 to the trough 14 to deliver feed thereinto. The open side 16 of the feeder is the planar area defined along distal edges 18a and 22a of the end walls 18 and eave 22 respectively opposite the feed storage container 20. Access to the trough 14 by grazing livestock can only be achieved through the open side, as the trough is essentially enclosed for this purpose on three of its four sides by the end walls 18 and the container 20 opposite the open side 16.

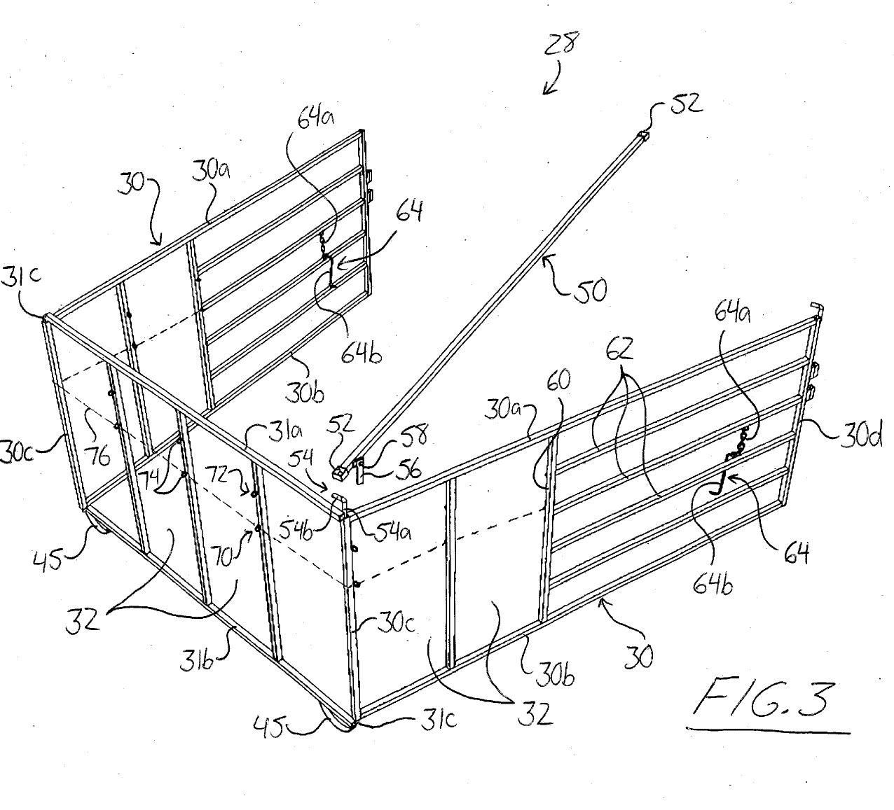

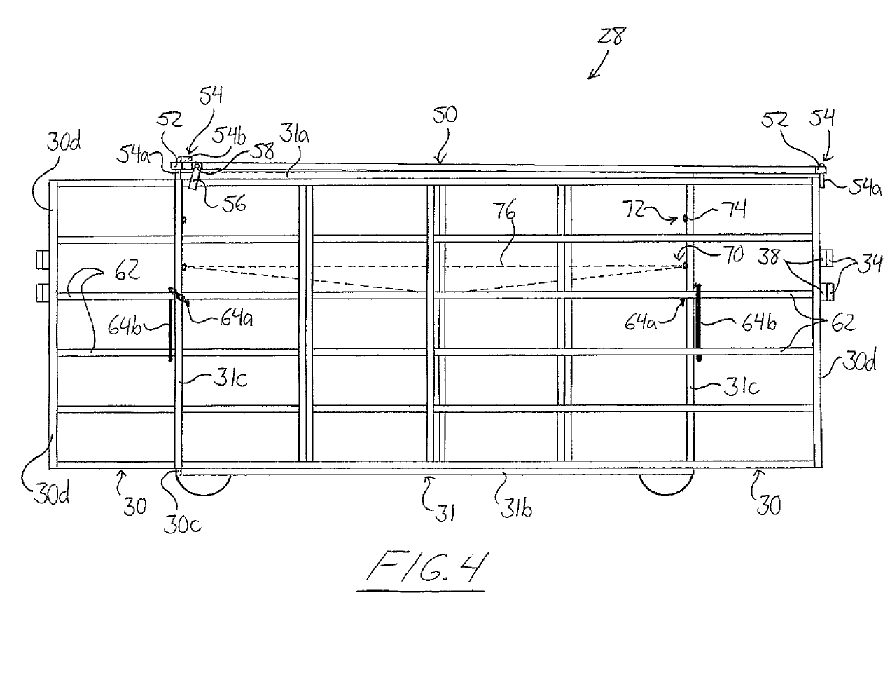

The feeder 10 differs from a conventional creep feeder in that its panel assembly 28 features three panels pivotally interconnected so as to allow folding of one panel over an adjacent panel connected thereto about a vertical axis. At opposite ends of the panel assembly 28, defined by end panels 30 between which a side panel 31 is connected, the assembly is pivotally mounted about vertical axes to the end walls 18 of the feeder's enclosure 12. The folding panel assembly 28 thus acts essentially like a planar four-bar linkage, in which ground is defined by the straight line horizontal distance between the pivotal connections to the end walls, movable along a horizontal plane. FIG. 3 shows the foldable panel assembly 28 in a fully deployed condition in which the end panels 30 project laterally from the enclosure 12 away from the open side 16 thereof with a slight convergence toward one another to support the side panel 31 in a position parallel to the open side 16 at a distance therefrom opposite the trough 14. In this condition, the foldable panel assembly 28 cooperates with the enclosure such that the end panels 30, end walls 18, storage container 20 and side panel 31 surround a feeding area in which the trough 14 is disposed. Each panel features gates 32 sized to allow entry to this feeding area by young livestock that have yet to be weaned so that they may reach supplemental feed disposed within the trough 14, while preventing entry by older, larger livestock. As shown in FIG. 4, when transport of the feeder 10 becomes necessary, the panels are folded up over one another about their vertical pivot axes into a generally flat, face-to-face stowed condition extending between the connections to the end walls without projecting significantly outward from the enclosure 12 past the open side 16 thereof. As the motion of the interconnected panels between these two conditions is almost entirely horizontal, access to the trough 14 through the open side by older, larger livestock is prevented at all times with the panel assembly 28 installed.

In the illustrated embodiment, the two end panels 30 are of an equal length that exceeds that of the side panel 31 with the straight-line distance between the connection points of the panel assembly 28 to the enclosure 12 being greater in length than any of the panels. The sum of the distance between the two connection points between the panel assembly and the enclosure and the length of the side panel 31 is equal to the sum of the lengths of the two end panels 30. The panel assembly of the illustrated embodiment can be moved between the stowed and deployed conditions by manually moving the connection point between one of the end panels 30 along its arcuate path about the connection of the end panel to the enclosure 12. Setting up or collapsing down the creed feeder can thus be easily effected by an individual while keeping access to the trough 14 by larger livestock blocked at all times.

As can be seen in FIGS. 3 and 4, the side panel 31 is slightly greater in height than the end panels 30, which are equal to each other in height. This is done to position the side panel's top rail 31a and bottom rail 31b just above and below the top rails 30a and bottom rails 30b of the end panels 30. A vertically extending end rail 30c of each end panel 30 nearest the side panel 31 is made of hollow square tubing with inner dimensions exceeding an outer diameter of a round, vertically extending end rail 31c at a respective end of the side panel 31. The square tubing end rail 30c is fixed to the top and bottom rails 30a, 30b of the end panel 30 at the ends thereof nearest the side panel 31 so as to leave its open ends unobstructed. The round end rail 31c of the side panel 31 depends downward from the top rail 31a thereof to the bottom rail 31b through the hollow interior of the square tubing end rail 30c. This defines the hinge-like pivotal joint between the end panel 30 and the side panel 31, with the square tubing end rail 30c forming the knuckle of the hinge and the round end rail 31c defining the pin extending therethrough. It should be appreciated that other pivotal structures known to those of skill in the art may be applied between the interconnected panels while still providing the advantage of the foldable panel assembly, but that doubling the use of the end rails of the panels as pivotal joint components reduces the number of parts in the assembly.

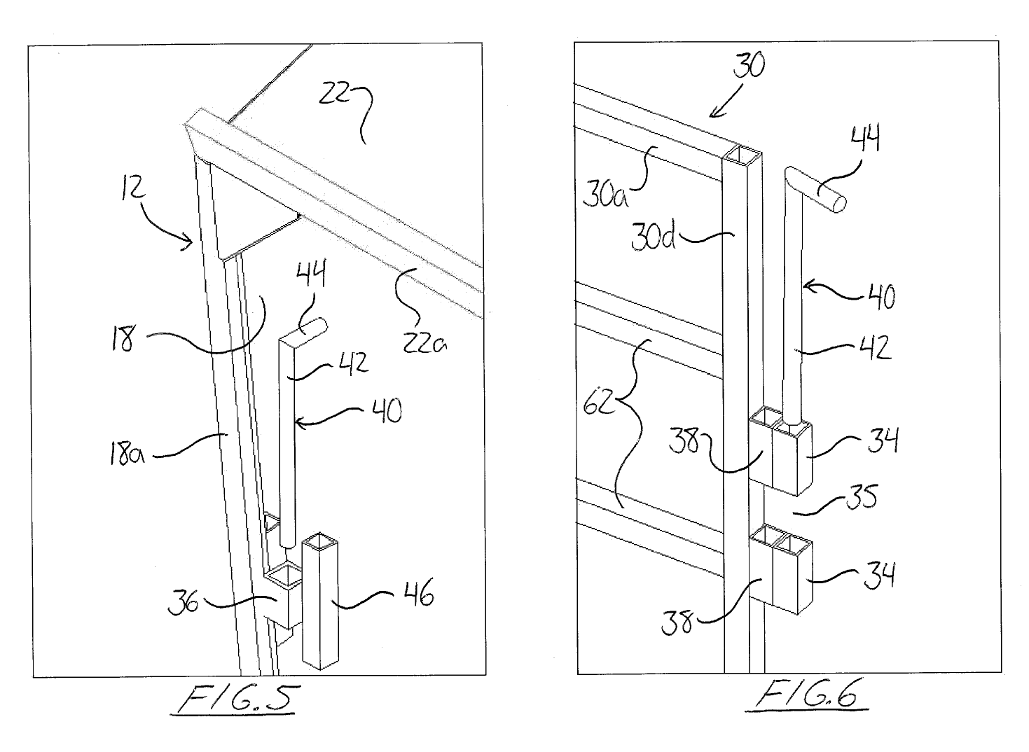

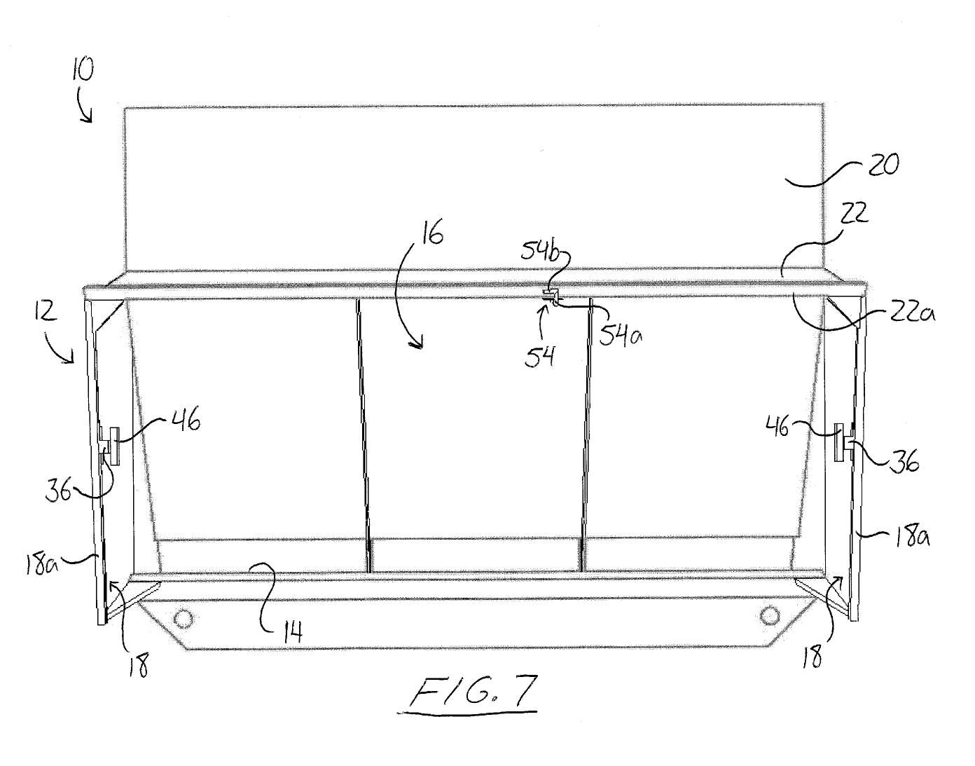

An end rail 30d of each end panel 30 defines a respective end of the foldable panel assembly 28 at which the assembly attaches to the enclosure 12 of the feeder for pivotal motion relative thereto. As shown in FIG. 6, two hinge knuckles 34 are fixed on the end rail 30d of the end panel 30 to project outward therefrom at spaced apart positions therealong to form a vertical gap 35 between them into which a corresponding hinge knuckle 36 on the respective end wall 18 of the feeder's enclosure 12, as seen in FIG. 5, is receivable. Each knuckle 34 of the end panel 30 is defined by a length of hollow square tubing fixed to a spacer 38, which in turn is fixed to the end rail 30d on a face thereof opposite that from which the top and bottom rails 30a, 30b extend. To install the panel assembly 28 onto the enclosure 12 of the feeder 10, the end panel 30 is positioned to fit the enclosure knuckle 36 within the vertical gap 35 between the panel knuckles 34 to align the openings extending through all three knuckles about a vertical axis. A pin 40 featuring a shaft 42 with an outer diameter less than the inner dimensions of all three square tubing knuckles has a projection 44 at its top end projecting radially outward from the shaft 42 to form a stop. The pin 40 is lowered to extend its shaft 42 through the three hinge knuckles on the end panel 30 and feeder enclosure 12 with the projection 44 extending outward past the walls of the uppermost knuckle on the end panel 30 to prevent the pin 40 from falling therethrough. The end panel 30 is thus supported on the end wall 18 of the enclosure 12 for pivotal motion about the pin shaft's longitudinal axis. The end panels 30 are supported on the feeder enclosure 12 at a height above the ground and project laterally outward therefrom above the ground with feet 45 mounted to the bottom of the side panel's bottom rail 31b at opposite ends thereof to engage the ground and help support the assembly.

As shown in FIGS. 5 and 6, each of the hinge knuckles mounted to the end panel 30 and end wall 18 of the feeder enclosure 12 has a hollow interior of greater cross-sectional size than the pin shaft 42, and the enclosure knuckle 36 has a hollow interior of greater cross-sectional size than the panel knuckles 34. This creates spacing between the pin shaft 42 and the panel knuckles 34, and even greater spacing between the pin shaft 42 and the enclosure knuckle 36, so as to create a significant amount of hinge play between the panel assembly 28 and the feeder enclosure 12. This allows automatic change in the height at which the side panel 31 sits relative to that of the feeder enclosure 12 in response to variation in the ground surface from one feeding location to another. In other words, the hinge play allows a certain amount of tilting of the panel assembly about a horizontal axis extending between the two enclosure knuckles 36 on the opposite end walls 18. In a more vertically rigid mounting arrangement with relatively insignificant play in the pivotal connections between the panel assembly 28 and the feeder enclosure 12, an increase in elevation from the ground on which the feeder frame rests to that on which the side panel 31 is to rest in the deployed condition may prevent full deployment of the panel assembly, while a decrease would result in the side panel 31, including feet 45, being supported above the ground in a cantilever fashion by the end panels 30.

Based on the preceding paragraph, it should be appreciated that due to the intentional hinge play and the likelihood of use of the feeder on a ground surface that is not horizontally planar, it should be appreciated that use of the terms vertical and horizontal herein are intended to distinguish upright directions from those lateral thereto, and that while the pivotal connections of the panel assembly should be as parallel as possible to ensure proper movement, it is not essential that they are oriented to extend perfectly vertically or that the movement of the panels be carried out in a perfectly horizontal plane.

As shown in FIG. 5, a blocking member 46 fixed to the hinge knuckle 36 of the feeder enclosure 12 to limit the tilting of the panel assembly 28, allowed by the play in the hinge-like pivotal connections to the enclosure, when in the stowed condition. In the illustrated embodiment the blocking member 46, like the panel knuckles 34 and spacers 38 therefore, is formed of a length of hollow square tubing. The vertically extending tubular blocking member 46 is longer than the tubular knuckle 36 on which it is mounted and is vertically offset therefrom to extend both upward and downward therefrom. The blocking member 46 is fixed to a face of the knuckle 36 opposite the end wall 18 within the enclosure and is horizontally offset from the longitudinal axis of the knuckle 26 further into the enclosure, that is away from the open side 16, toward the trough 14. The spacers 38 not only position the panel knuckles 34 away from the end rail 30d of the end panel 30 so as to avoid contact between the end rail 30d and the enclosure knuckle 36 during pivoting of the panels between the deployed and stowed conditions, but also act to engage into face to face contact with the blocking member 46 projecting upward and downward from the enclosure knuckle 36 when the end panel 30 is pivoted sufficiently toward the trough 14 into the stowed condition. This contact above and below the enclosure knuckle prevents tilting of the panel assembly about the horizontal axis between the two vertically aligned enclosure knuckles on the opposite end walls 18 when in the stowed condition. In a portable feeder having a wheel supported on the frame between the trough and the stowed panel assembly, preventing such tilt avoids contact between the panels and the wheel during transport. The horizontal offsetting of the blocking member 46 relative to the enclosure knuckles 36 is sufficient to allow the end panel 30 to extend substantially parallel to the open side 16 of the enclosure.

Although the pivotal connection between the end panel 30 and the feeder enclosure 12 need not necessarily be mounted specifically on the inner surface of the end wall 18, it should be supported near the distal edge 18a thereof to allow the pivotal range necessary to deploy and retract the panel assembly. For example, the three section panel assembly of the illustrated embodiment requires that the end panel 30 being manually maneuvered to operate the foldable panel assembly 28 to pivot past alignment with the respective end wall 18 during unfolding of the panel assembly to the fully deployed condition. Positioning the pivotal connection too far toward the trough 14 from the distal edge 18a may detrimentally limit the pivotal range of the end panel 30 in this embodiment due to eventual contact with the end wall 18.

Pivotal connections between the panel assembly 28 and the feeder enclosure 12 other than the structure shown in the figures and described herein above may be applied while still allowing the foldable panel to be deployed and stowed. However, providing knuckles supported on both the enclosure and the end panels for use with a removable pin allows easy removal of the panel assembly, for example for use of the creep feeder as a self feeder for fully grown livestock without requiring lifting of the panel assembly. It will be appreciated by those of skill in the art that the blocking members 46 need not be mounted directly on the knuckles 36 mounted to the enclosure, and similarly that the knuckles 36 may be supported on the frame in ways other than by direct mounting to the end walls 18.

As shown in FIG. 3, a locking member 50 is provided in the form of an elongate bar having open ends 52 each defining an aperture extending traverse to the longitudinal axis of the locking member. The locking member 50 is connectable to the panel assembly at one of its open ends and to the feeder enclosure 12 at the other of its open ends to lock the panel assembly in the fully deployed condition for use. The locking member connects to the panel assembly 28 at the pivotal joint between one of the end panels 30 and the side panel 31 and connects to the feeder enclosure 12 at a distance from the pivotal connection of the same end panel to the enclosure 12. As shown in the figures, hooks 54 are provided for use with the locking member 50, one on top of the panel assembly 28 at of the pivotal connection between the end panel and the one side panel and another mounted to the eave 22 of the enclosure 12 at a distance therealong from the end wall 18 to which the end panel 18 is connected. Each hook is L-shaped, with a shank 54a projecting upward and a projection 54b extending laterally therefrom at a top end. As seen in FIG. 3, the hooks face the same direction, that is, the projections 54b extend in generally the same direction, with the panel assembly in the fully deployed condition. The bent hooks 54 require that the open ends 52 of the locking member first be horizontally slid over the projections 54b and that the locking member then be twisted about its longitudinal axis to drop the open ends 52 down around the shanks 54a. With the ring-like open ends 52 so disposed about the hook shanks 54a, the length of each of the projections 54b is such that it extends beyond the opening in the end of the locking member to prevent removal of the locking member 50 by linear vertical lifting without twisting.

The positioning of each ring-like open end 52 about the respective hook shank 54a allows pivoting of the locking member thereabout, but the locking member and the end panel limit the motion of the hook 54 at the joint between the end panel and the side panel due to different arcuate paths that do not coincide. Thus movement of this joint is prevented with the locking member in place. Locking this joint in place similarly locks the joint between the side panel 31 and the other end panel in place, as it is then similarly limited to two non-coincidental arcuate paths by the side panel and the other end panel. A single locking member locking one joint of the foldable panel assembly 28 thus acts to lock each of the panels thereof in place in the deployed condition.

Although the hooks 54 act to inhibit inadvertent withdrawal of the locking member, an additional locking mechanism is provided to ensure it remains in place once installed over the hooks 54. A blocker 56 is provide in the form of a small strip-like plate secured to the locking member proximate one of the open ends 52 thereof by a pivot pin 58. For employment of the locking member 50, the blocker 56 is pivoted to extend along the locking member 50 and the open end proximate the blocker 56 is slid and twisted over the hook 54 at the joint between the end panel and side panel until disposed about the shank 54a. With the locking member 50 so in place, the blocker 56 is pivoted out of alignment therewith so as to project downward therefrom between the locking member 50 and the end panel 30. Attempts to twist the locking member 50 to slide the open ends from off the hook shanks 54a to about the projections 54b thereof for withdrawal are blocked by contact between the blocker 56 and the top rail 30a of the end panel, thus locking the locking member in place until the blocker 56 is once again pivoted upward to extend along the locking member or upward therefrom to allow unobstructed withdrawal.

The hook 54 at the joint between the end panel 30 and the side panel 31 also functions as a part of a storage device for retaining the locking member 50 when not in use. Another hook 54 is provided at the end rail 30d of the same panel, opposite the other hook on the panel assembly 28, projecting upward from the top rail 30a. The end panel 30 and the locking member 50 are of similar length such that the open ends 52 thereof will fit over the hooks 54 on the end panel to store itself thereatop as shown in FIG. 4. To prevent inadvertent withdrawal of the locking member 50 from atop the end panel 30 in the stowed condition, the hooks 54 acting to support the locking member 50 in this storage position are mounted on opposite ones of the end panel 30 and the side panel 31 such that they face generally the same direction with the panel assembly 28 in the fully deployed condition but face angularly offset directions in the fully stowed condition due to relative pivoting between the panels from one condition to the other. As shown in FIG. 4, with hook projections 54b extending at approximately perpendicular directions and each projecting past the inner dimension of the respective open end 52 of the locking member 50, withdrawal of the locking member 50 from atop the end panel 30 is prevented, as the rotation or twisting needed to remove one open end is blocked by engagement of the other end with the respective hook. In other words, the projections extend in, or the mouths of the hooks (the open space between the shanks and projections) open, in a similar direction in the deployed condition, but in directions offset enough to prevent withdrawal in the stowed condition.

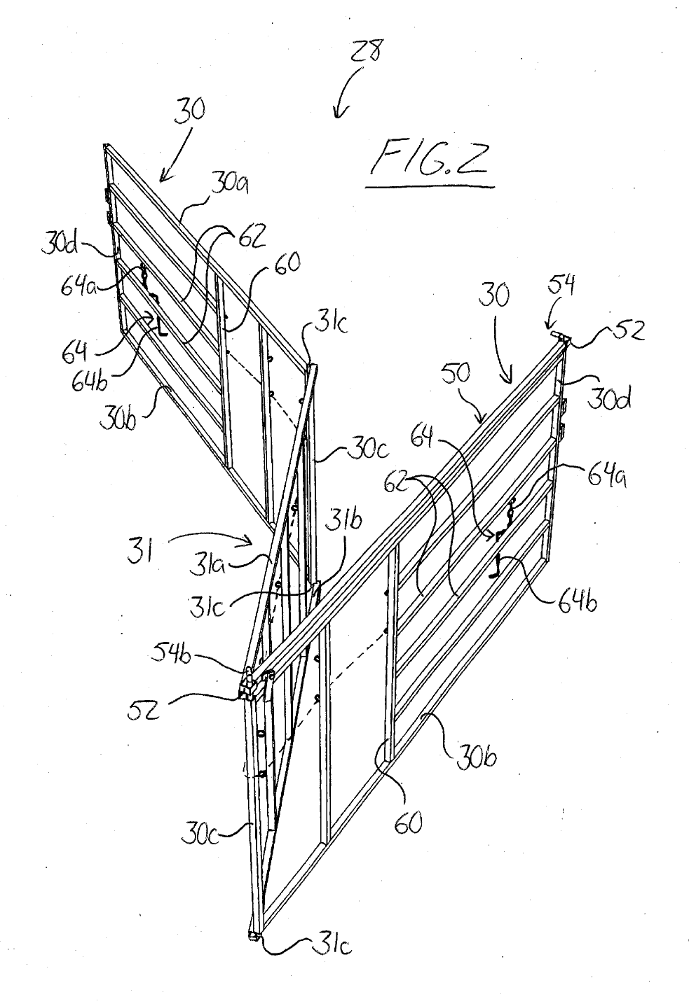

As shown in FIG. 3, the hook 54 at the joint between the end panel and side panel may have its shank formed by an extension of the round end rail 31c forming the pivot pin of this join of the end panel upward past the top rail 31a of the side panel 31. The top and bottom rails 31a and 31b of the side panel are fixed to the side of the round end rail 31c forming the hook shank 54a which allows better collapse of the end panel and side panel to a generally flat stowed condition by offsetting the pivot axis between them from the intersection of their longitudinal axes. For the same reason, as can be seen in FIG. 2, the top and bottom rails 31a and 31b of the side panel 31 are fixed to the opposite side of the other round end rail 31c opposite that with the hook 54 to provide a close fit collapse against the other end panel.

Each panel of the panel assembly 28 features gates 32 defined as the open space between two adjacent vertical rails of the panel. As shown in FIG. 3, the gates 32 of the side panel 31 are defined immediately adjacent one another and extend the full length of the panel. The end panels 30 on the other hand, do not have gates extending fully to the end rails 30d thereof at which they are connected to the feeder enclosure 12, but rather only have gates disposed proximate opposite end rail 30c at which they connect to the side panel 31. From vertical rail 60 closing the gate nearest the end rail 30d on the side the gate nearest thereto, a plurality of vertically spaced rails 62 extend to the end rail 31d parallel to the top and bottom rails 30a and 30b of the end panel 30. The vertically spaced rails 62 are sufficiently close together to prevent livestock from sticking their heads between the rails far enough to reach the trough 14. Thus young livestock must enter the feeding area through the gates 32 in order to consume the supplement feed within the trough, and older weaned livestock, being to large to pass through the gates 32, are prevented from reaching the trough 14 at all.

The vertically spaced, parallel rails 62 act to space the gates 32 of the end panels 30 from the end rails 30d thereof, thereby ensuring that all gates of the panel assembly 28 are spaced from the opposite ends thereof at a suitable distance from the trough 14 to prevent weaned livestock from accessing the trough 14 by passing their heads through the gates. Compared to a prior art rigid panel assembly upwardly pivotable to a stowed condition, the end panels 30 can be made longer without increasing the transport height of the feeder. This significant end panel length allows closing of the end panels at sections thereof nearest the feeder enclosure while still providing one or more gates each for the entry of young livestock. It should be appreciated that the portions of the end panels 30 proximate the opposite ends of the assembly may be closed off from access by livestock by means other than vertically spaced apart rails or bars, for example, by a solid sheet or plate of material or by horizontally spaced, vertically extending bars. The use of spaced rails may offer an improved strength to weight ratio relative to a fully closed panel section, while the use of vertically spaced members also cooperates with other components to provide another function explained herein below.

As shown in FIG. 3, locking devices 64 are provided, one on each of the end panels 30, to secure together all the panels of the assembly in the fully stowed condition. Each locking device 64 features a length of chain 64a fastened at one end to one of the vertically spaced rails 62 of the end panel 30. At the opposite end, the length of chain 64a is fastened to an S-shaped hook 64b. As shown in FIG. 4, when the panel assembly 28 is folded into the stowed condition, each chain 64a is wrapped around the end rail 30c of the opposite end panel, through which a respective end rail 31c of the side panel 31 passes to form a pivotal connection as explained herein above. With the chain 64a wrapped around the pivotal connection between the side panel 31 and the end panel opposite that to which it is fixed, the opposite ends of the S-shaped hook 64b are engaged to opposite ones of an adjacent pair of the vertically spaced rails 62. The chain 64a is thus tied around an end rail 31c of the side panel 31 with each of its ends secured to the end panel 30, one permanently by a fixed fastener and the other releasably by the S-shaped hook 64b. This prevents the side panel 31 from pivoting relative to the respective end panel 30 about the joint between them. Therefore, with both of the locking devices secured around the two end rails 31c of the side panel 31, the panel assembly is locked in the stowed condition.

It should be appreciated that many different locking devices are well-known and may be applied to secure the panels in fixed positions relative to one another in the stowed condition. For example, even in the type of locking device described herein above, the chain may be replaced by another flexible member, such as a cable, wire or rope and the S-shaped hook may be replaced with some other type of releasable fastener, such as a carabineer, for securing to a suitable connection point on the end panel or even back onto the chain itself after sufficient wrapping thereof. As another example, closed-biased clamps may be provided on the end panels for releasably clamping around the vertical rails at the pivotal joints at the ends of the side panel.

The panel assembly 28 further includes an arrangement for adjusting the height of the gates 32 thereof. Two sets 70, 72 of rings 74 are fastened to the panel assembly 28 at spaced points therealong to define two different heights at which a chain, represented by broken line 76, can be supported to define an upper limit of each gate 32. Each vertical rail extending upward from the bottom rails 30b, 31b of the rail assembly to the top rails 30a, 31a thereof to define a side of one or more of the gates 32 through which young livestock can pass to access the feed trough 14 has two rings 74 fastened thereto at spaced vertical positions therealong. The uppermost ring on each of these vertical rails is positioned therealong at the same height as the uppermost rings of the other vertical rails while the lowermost ring similarly aligns with the lowermost rings of the other rails, thereby defining the two vertically spaced sets 70, 72. The chain 76 is fed through one of the two sets 70, 72 of rings 74 to define the height of the gates 32. Having two or more sets of rings allows adjustment of the chain to one of a plurality of possible heights for adjustment of the gate size. The chain is locked at its ends to prevent passage of its ends through the rings, thereby ensuring the chain remains in place until the user unlocks the ends to change the gate height. Using an elongate flexible member, such as a chain, rope, cable or wire allows a single member to define the height of the gates on all the panels, as it can bend as needed to move with the panels during motion thereof between the fully deployed and stowed conditions. The rings may be replaced with hooks or releasable fasteners for releasably supporting the flexible chain, or the multiple sets of supports may be replaced with a single set of supports spaced along the panel assembly from one panel to the next and mounted for slidable movement up and down and locking at selective heights.

It should be appreciated that the number of panels, gates and locking members may be altered within the scope of the present invention. However, the three panel construction illustrated and described above has certain advantages over embodiments with additional panels. Movement of the panel assembly between the fully deployed and stowed conditions can be effected by manually moving only one of the end panels 30, just as motion of the assembly out of the fully deployed condition can be prevented by locking only one of the pivotal connections with the side panel (by use of the locking member).

The foldable panel assembly may be mounted to feeders other than the portable type shown in the figures, so long as there is provided some type of enclosure for preventing access thereto except through an open side on which the panel assembly is mountable. It should also be appreciated that although only one side of the illustrated feeder is shown in the figures, the other side is of substantially the same structure, having a trough, an enclosure with end walls and an eave, and a foldable panel assembly.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A creep feeder comprising:
a frame;
an enclosure defined on the frame;
a trough supported within the enclosure, the enclosure blocking access to the trough from three sides thereof while defining an open side of the feeder through which the trough is accessible, the enclosure including end walls disposed at opposite ends of the trough;
a panel assembly having opposite ends pivotally supported on the frame proximate the end walls of the enclosure and comprising a plurality of panels pivotally interconnected between the opposite ends to allow folding of the panel assembly;
the panels being foldable from a deployed condition, in which the panel assembly extends from the opposite ends thereof proximate the end walls in a direction away from the trough through the open side to enclose a feeding area spanning from the trough past the open side of the feeder, to a stowed condition in which the panel assembly extends between the end walls in proximity to the open side to effect closing thereof.

2. The creep feeder according to claim 1 wherein the panel assembly comprises two end panels each pivotally mounted proximate a respective one of the end walls and a side panel extending between the two end panels at an end of the feeding area opposite the trough with the panel assembly in the deployed condition.

3. The creep feeder according to claim 2 wherein the two end panels are of generally equal length.

4. The creep feeder according to claim 2 wherein the side panel is shorter in length than each of the two end panels.

5. The creep feeder according to claim 2 wherein a sum of a linear distance between the opposite ends of the panel assembly and a length of the side panel is generally equal to a sum of lengths of the two end panels.

6. The creep feeder according to claim 2 wherein each end panel comprises at least one gate spaced at a distance from a respective one of the ends of the panel assembly.

7. The creep feeder according to claim 1 wherein each panel comprises at least one gate.

8. The creep feeder according to claim 7 wherein each gate is spaced along the panel assembly from each of the opposite ends thereof.

9. The creep feeder according to claim 7 further comprising a flexible elongate member extending along the panel assembly between top and bottom limits thereof from one panel to another to define a height of a plurality of gates.

10. The creep feeder according to claim 9 wherein the flexible elongate member is supportable at varying heights on the panel assembly to vary the height of the plurality of gates.

11. The creep feeder according to claim 1 further comprising at least one locking device for locking two of the panels together in the stowed condition.

12. The creep feeder according to claim 11 wherein each locking device comprises a flexible element secured at a first end to a respective one of the two panels for tying to the other of the two panels.

13. The creep feeder according to claim 12 wherein a second end of the flexible element opposite the first end has a securing element thereon for securing the second end back onto the respective one of the two panels after wrapping the flexible element around a member of the other of the two panels.

14. The creep feeder according to claim 13 wherein the securing elements comprises an S-hook sized to hook around and span between a pair of vertically spaced rails extending along the respective one of the two panels.

15. The creep feeder according to claim 1 further comprising an elongate locking member connectable at a first end thereof to the panel assembly proximate an axis about which two of the panels pivot relative to one another and connectable at a second end opposite the first end to the frame with the panel assembly in the deployed condition to inhibit movement of the panel assembly.

16. The creep feeder according to claim 15 wherein the panel assembly comprises a mounting device to which the locking member is mountable to extend along a respective one of the plurality of feeder panels for storage.

17. The creep feeder according to claim 16 wherein the mounting device comprises a pair of hooks disposed at opposite ends of one of the two panels over which open ends of the locking member are slidable, the hooks being dimensioned to project beyond an inner dimension of the open ends with the open ends fitted about shanks of the hooks.

18. The creep feeder according to claim 15 wherein the panel assembly comprises a hook proximate the axis about which the two panels pivot, the hook being sized to allow sliding of one of the open ends of the locking member thereover to a shank thereof to prevent linear withdrawal of the open end therefrom.

19. The creep feeder according to claim 18 further comprising a blocker pivotally mounted to the locking member proximate the one of the open ends thereof, the blocker being pivotable with said on of the open ends fitted over the shank of the hook to depend downward from the locking member and block rotation of the locking member for removal from the hook by engagement with one of the two panels.

20. The creep feeder according to claim 1 wherein pivotal connections at the opposite ends of the panel assembly each comprise at least one knuckle having a pin removably extending therethrough, the at least one knuckle having an inner diameter exceeding an outer diameter of the pin to allow tilt of the panel assembly relative to the enclosure in the deployed condition.
